(19) United States
(12) Patent Application Publication
(10) Pub. No.: US 2023/0061129 A1
(43) Pub. Date: Mar. 2, 2023

(54) GRAIN COLOR SORTER WITH FILTER DEVICE

(71) Applicant: Chun Hung LUK, Hong Kong (HK)

(72) Inventor: Chun Hung LUK, Hong Kong (HK)

(21) Appl. No.: 17/652,097

(22) Filed: Feb. 22, 2022

(30) Foreign Application Priority Data
Aug. 24, 2021 (CN) 202122001538.2

(51) Int. Cl. B01D 46/24; B01D 46/42; B01D 46/00; B07C 5/02

(52) U.S. Cl. CPC B01D 46/2411; B01D 46/4227; B01D 46/001; B07C 5/02; B01D 2279/35; B07C 5/3425

(57) ABSTRACT

A grain color sorter with a filtering device is provided. The filtering device includes a hopper, a drop tube, a sleeve sleeved on the drop tube, a ventilation duct and a filter cartridge. The drop tube is communicated with a feed inlet of a body and a feed outlet of the hopper, a wall of the drop tube is defined with a first through hole through which inside of the drop tube is communicated with the sleeve. The ventilation duct in which a fan is installed is communicated with inside of the sleeve. One end of the filter cartridge is detachably connected with an end cap, the other end thereof is provided with an opening, a wall of the filter cartridge is defined with a second through hole, a filter screen is installed inside the filter cartridge and at an end of the filter cartridge close to the opening.

### CROSS-REFERENCE TO RELATED APPLICATIONS

This is a U. S. patent application which claims the priority and benefit of Chinese Patent Application Number 202122001538.2, filed on Aug. 24, 2021, the disclosure of which is incorporated herein by reference in its entirety.

### TECHNICLAL FIELD

The disclosure relates to a technical field of grain sorting equipment, in particular to a grain color sorter with a filtering device.

### BACKGROUND ART

A color sorter is a device that automatically sorts out heterochromatic particles in granular materials using photoelectric detection technologies according to difference in optical characteristics of the materials. Currently, the color sorter is used in fields of bulk materials or packaging industrial products, food quality inspection and grading.

A grain color sorter mainly aims at color sorting of grains to sort out discolored grains. However, for existing grain color sorters, dust removal is not made for the grains when the grain color sorters are fed, and some grains contain a large amount of dust, which affects processing quality of the grains.

### SUMMARY

The disclosure provides a grain color sorter with a filtering device, which can filter and remove dust from grains entering the grain color sorter, and improve processing quality of the grains.

Embodiments of the disclosure can be realized as follows.

A grain color sorter with a filtering device is provided in an embodiment of the disclosure, which includes a filtering device. The filtering device includes a hopper, a drop tube, a sleeve, a ventilation duct and a filter cartridge.

The drop tube and the sleeve are both connected with a body of the grain color sorter, the body is provided with a feed inlet, the drop tube is communicated with the feed inlet, a wall of the drop tube is defined with a first through hole, the sleeve is sleeved on the drop tube and has a gap with the drop tube, and an inside of the drop tube is communicated with the sleeve through the first through hole. A feed outlet of the hopper is communicated with the drop tube.

The ventilation duct is communicated with inside of the sleeve, and a fan is installed in the ventilation duct.

one end of the filter cartridge is detachably connected with an end cap, the other end of the filter cartridge is provided with an opening, a wall of the filter cartridge is defined with a second through hole, the filter cartridge is communicated with the ventilation duct through the second through hole, a filter screen is installed inside the filter cartridge, and the filter screen is installed at an end of the filter cartridge close to the opening.

Further, the grain color sorter further includes a pull rod, a supporting piece and a limiting mechanism. The supporting piece is installed in the filter cartridge and slidably connected with the inner wall of the filter cartridge. The filter screen is fixed to the supporting piece. The supporting piece is defined with a third through hole. The pull rod is connected with the supporting piece. The limiting mechanism is used for fixing the supporting piece in the filter cartridge.

Further, an outer wall of the pull rod is provided with an annular groove which is circumferentially arranged along the pull rod. The limiting mechanism includes a limiting rod. An outer wall of the filter cartridge is defined with a guide hole and the limiting rod penetrates through the guide hole and can abut against the annular groove.

Further, the limiting rod is sleeved with a spring.

Further, the limiting rod is provided with a first limiting block and a second limiting block. The first limiting block is arranged outside the filter cartridge, the second limiting block is arranged inside the filter cartridge, and the spring is arranged between the second limiting block and the inner wall of the filter cartridge.

Further, the grain color sorter further includes an adjusting mechanism, which includes a movable plate, a connecting member and a fixing rod. An inner wall of the hopper is symmetrically provided with sliding grooves, the sliding grooves and the fixing rod are transversely arranged. The movable plate is movably connected with the sliding grooves. The fixing rod is fixed to an outer wall of the hopper. The fixing rod is defined with a plurality of adjusting grooves along its length direction. The hopper is defined with a third through hole. One end of the connecting member can penetrate through the third through hole to connect with the movable plate, and the other end of the connecting member can be plugged into one of the adjusting grooves.

Further, the connecting member is L-shaped, and the connecting member is movably connected with the movable plate through a bump, and the movable plate is provided with a recess, the bump is connected with the connecting member, the bump is arranged in the recess and can rotate relative to the recess, and a torsion spring is sleeved outside the connecting member, one end of the torsion spring is connected with the bump and the other end of the torsion spring is connected with the connecting member.

Further, it further includes a grounding device, which includes a connecting rod, a grounding rod embedded in the ground, an elastic member, an abutting member and a supporting piece connected with the body of the grain color sorter.

The abutting member is slidably matched with the connecting rod and can move along an axial direction of the connecting rod.

One end of the connecting rod is connected with the grounding rod, the other end of the connecting rod is defined with a limiting groove, the elastic member is arranged in the limiting groove, one end of the elastic member acts on the connecting rod and the other end of the elastic member acts on the abutting member to make the abutting member abut against the supporting piece.

Further, the abutting member includes a connecting bushing and a clamping seat. The bushing is sleeved on an outer wall of the connecting rod, the clamping seat is arranged at the other end of the connecting rod, and the other end of the elastic member acts on the clamping seat and makes the clamping seat abut against the supporting piece.

Further, the outer wall of the connecting rod is provided with a corrugated pipe one end of which is connected with the supporting piece and the other end of which is used for connecting with the ground.

The grain color sorter with the filtering device in the embodiment of this disclosure provides advantages that:

Grains fall into the drop tube from the hopper, and then enters the body for color sorting. When the grains are in the drop tube, because there is a fan in the ventilation duct, under an action of the fan, the air and dust enter the sleeve through the first through hole of the drop tube, then enter the ventilation duct through the sleeve, and then enter the filter cartridge; after being filtered by the filter screen, the dust is trapped, and the gas flows out from the opening of the filter cartridge. By disassembling the end cap, the trapped dust can be removed from the filter cartridge. The grain color sorter of this embodiment presents good dust removal effect, which can reduce dust content in the grains and improve processing quality of the grains.

### BRIEF DESCRIPTION OF THE DRAWINGS

In order to illustrate technical schemes of embodiments of this disclosure more clearly, the following drawings used in the embodiments will be briefly introduced; it should be understood that the following drawings only show some embodiments of this disclosure, therefore they should not be regarded as a limiting of the protection scope; and other related drawings can be obtained according to these ones without creative effort for ordinary skilled in the art.

FIG. 1 is a schematic structural diagram of a grain color sorter according to an embodiment of this disclosure;

FIG. 2 is an enlarged view of area A in FIG. 1;

FIG. 3 is a schematic structural diagram of a supporting piece according to an embodiment of this disclosure;

FIG. 4 is a structural schematic diagram of an adjusting mechanism according to an embodiment of this disclosure; and

FIG. 5 is an enlarged view of area B in FIG. 1.

Reference Number: 10—Grain Color Sorter; 101—Body; 11—Filtering Device; 111—Hopper; 1111—Groove; 112—Drop Tube; 1121—First Through Hole; 113—Sleeve; 114—Ventilation Duct; 1141—Fan; 115—Filter Cartridge; 1151—end cap; 1152—Opening; 1153—Second Through Hole; 1154—Filter Screen; 1155—Pull Rod; 1155a—Annular Groove; 1156—Supporting Piece; 1156a—Third Through Hole; 1157—Handle; 116—Threaded Tube; 117—Limiting Mechanism; 1171—Limiting Rod; 1172—Spring; 1173—First Limiting Block; 1174—Second Limiting Block; 118—Adjusting Mechanism; 1181—Movable Plate; 1181a —Recess; 1182—Connecting Member; 1183—Fixing Rod; 1183a—Adjusting Groove; 1184—Bump; 30—Grounding Device; 31—Ground; 32—Grounding Rod; 33—Connecting Rod; 331—Limiting Groove; 34—Corrugated Pipe; 35—Abutting Member; 351—Bushing; 352—Clamping Seat; 3521—Groove; 36—Elastic Member; 37—Supporting Piece; 371—Bump; 20—Body; 21—Wheel.

### DETAILED DESCRIPTION

In order to make the purposes, technical schemes and advantages of embodiments of this disclosure more clear, the technical schemes in the embodiments of this disclosure will be described clearly and completely with reference to the drawings in the embodiments of this disclosure; and it is Obvious that the described embodiments are part of the embodiments of this disclosure, but not all of them. The components of the embodiments of the disclosure generally described and illustrated in the drawings herein can be arranged and designed in various different configurations.

Therefore, the following detailed description of the embodiments of the disclosure provided in the drawings is not intended to limit the claimed scope of the disclosure, but only shows selected embodiments of the disclosure. On a basis of the embodiments in this disclosure, all other embodiments obtained by the ordinary skilled in the art without any creative effort are within the protection scope of this disclosure.

It should be noted that similar reference numerals and letters indicate similar items in the following figures, thus once an item is defined in one figure, it is not necessary to further define and explain it in subsequent figures.

In the description of this disclosure, it should be noted that the orientation or position relationships indicated by the terms such as “upper”, “lower”, “inner” and “outer” are based on the orientation or position relationships shown in the drawings, or the generally adopted orientation or position relationships when the products of this disclosure are used are only for convenience of describing this disclosure and for simplifying the description, but do not indicate or imply that the referred device or element must have a specific orientation, be constructed and operated in a specific orientation, and therefore cannot be understood as a limitation of this disclosure.

In the description of this disclosure, it should also be noted that unless otherwise specified and limited, the terms “providing”, “installing” and “connecting” should be understood in a broad sense, for example, it can be “fixedly connecting”, or “detachably connecting” or “integrally connecting”, or it can be “directly connecting” or “indirectly connecting through an intermediate medium”, or it can be “communicating within two elements”. For those ordinary skilled in the art, the specific meanings of the above terms in this disclosure can be understood according to specific situations.

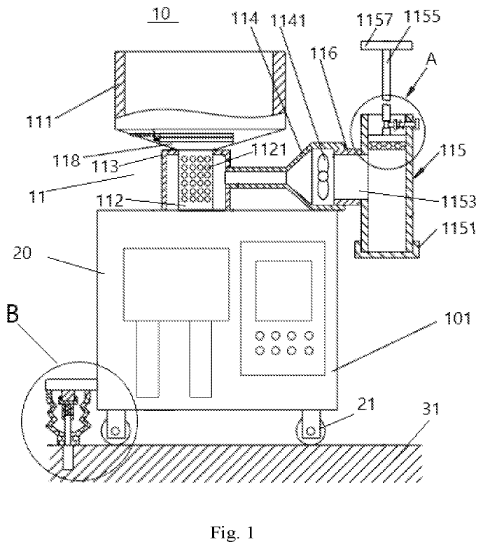

Referring to FIG. 1, a grain color sorter 10 with a filtering device 11 is provided in an embodiment of the disclosure, which includes a filtering device 11. The filtering device 11 includes a hopper 111, a drop tube 112, a sleeve 113, a ventilation duct 114 and a filter cartridge 115.

The drop tube 112 and the sleeve 113 are both connected with a body 101 of the grain color sorter 10, the body 101 is provided with a feed inlet, the drop tube 112 is communicated with the feed inlet, a wall of the drop tube 112 is defined with a first through hole 1121, the sleeve 113 is sleeved on the drop tube 112 and has a gap with the drop tube 112, and an inside of the drop tube 112 is communicated with the sleeve 113 through the first through hole 1121. A feed outlet of the hopper 111 is communicated with the drop tube 112.

Since the feed outlet of the hopper 111 communicates with the drop tube 112, and the drop tube 112 communicates with the feed port, the grains fall into the drop tube 112 from the hopper 111, and then can enter the body 101 for color sorting.

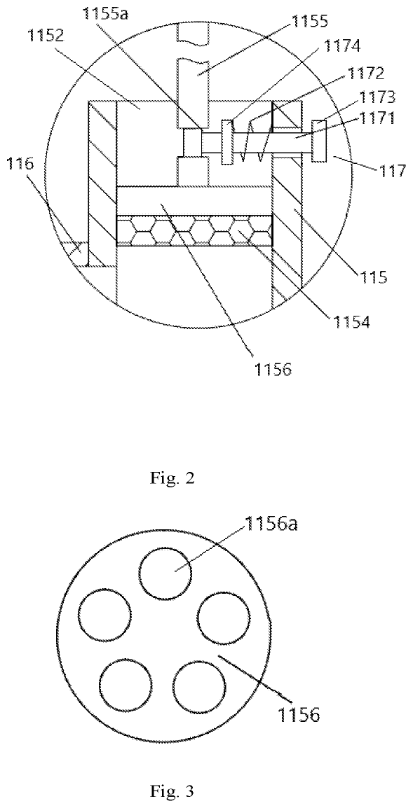

The ventilation duct 114 is communicated with an inside of the sleeve 113, and a fan 1141 is installed in the ventilation duct 114. An end of the filter cartridge 115 is detachably connected with an end cap 1151, the other end of the filter cartridge 115 is provided with an opening 1152, a wall of the filter cartridge 115 is defined with a second through hole 1153, the filter cartridge 115 is communicated with the ventilation duct 114 through the second through hole 1153, a filter screen 115 is installed inside the filter cartridge 1154 (referring to FIG. 2), and the filter screen 1154 is installed at an end of the filter cartridge 1152 close to the opening 115. Illustratively, the filter cartridge 115 is vertically arranged, the opening 1152 is arranged at a top of the filter cartridge 115, and the end cap 1151 is connected to a bottom of the filter cartridge 115.

When the grains pass through the dropping pipe 112, because there is a fan 1141 in the ventilation duct 114, under an action of the fan 1141, the air and dust enter the sleeve 113 through the first through hole 1121 of the drop tube 112, then enter the ventilation duct 114 through the sleeve 113, and then enter the filter cartridge 115; after being filtered by the filter screen 1154, the dust is trapped, and the gas flows out from the opening 1152 of the filter cartridge 115. By disassembling the end cap 1151, the trapped dust can be removed from the filter cartridge 115.The grain color sorter 10 of this embodiment presents good dust removal effect, which can reduce dust content in the grains and improve processing quality of the grains.

Illustratively, the ventilation duct 114 is connected with the filter cartridge 115 through a threaded pipe 116, one end of the ventilation duct 114 is threadedly connected with the threaded pipe 116, and the other end of the threaded pipe 116 is fixedly connected with the filter cartridge 115.

Further, referring to FIGS. 1 and 2, in an implementation, the grain color sorter 10 further includes a pull rod 1155, a supporting piece 1156 and a limiting mechanism 117. The supporting piece 1156 is installed in the filter cartridge 115 and slidably connected with the inner wall of the filter cartridge 115. The filter screen 1154 is fixed to the supporting piece 1156. The supporting piece 1156 is defined with a third through hole 1156a (referring to FIG. 3). The pull rod 1155 is connected with the supporting piece 1156. The limiting mechanism 117 is used for fixing the supporting piece 1156 in the filter cartridge 115. The supporting piece 1156 is closer to the opening 1152 of the filter cartridge 115 than the filter screen 1154.

After the filter screen 1154 operates for a long time, some dust will remain on the filter screen 1154. When the pull rod 1155 pulls the support piece 1156 to move along a height direction of the filter cartridge 115, the support piece 1156 drives the filter screen 1154 to move, so that a part of the dust on the filter screen 1154 can be shaken off, thus preventing the dust on the filter screen 1154 from blocking filtering of the filter screen 1154.The limiting mechanism 117 can fix the supporting piece 1156 in the filter cartridge 115, thus ensuring a normal operating state of the filter screen 1154.Since the supporting piece 1156 is also defined with a third through hole 1156a, after the dust is filtered by the filter screen 1154, the gas can flow out from the third through hole 1156a and finally out of the opening 1152 of the filter cartridge 115.Illustratively, the supporting piece 1156 is made of stainless steel.

Optionally, an end of the pull rod 1155 is provided with a handle 1157, through which the pull rod 1155 can be conveniently moved.

Further, an outer wall of the pull rod 1155 is provided with an annular groove 1155a which is circumferentially arranged along the pull rod 1155. The limiting mechanism 117 includes a limiting rod 1171. An outer wall of the filter cartridge 115 is defined with a guide hole and the limiting rod 1171 penetrates through the guide hole and can abut against the annular groove 1155a.

When the support piece 1156 needs to be fixed at a certain position, the stop rod 1171 is moved along the guide hole and abutted in the annular groove 1155a, so that the pull rod 1155 cannot move, that is, the support piece 1156 is fixed at a certain position. When the dust on the filter screen 1154 needs to be cleaned, the limiting rod 1171 is moved along the guide hole, so that an end of the limiting rod 1171 is separated from the annular groove 1155a, and the pull rod 1155 can move along an axial direction of the filter cartridge 115 without being hindered by the limiting rod 1171.

Optionally, the limiting rod 1171 is sleeved with a spring 1172, and the spring 1172 serves to make the limiting rod 1171 abut against the annular groove 1155a more stably.

Further, the limiting rod 1171 is provided with a first limiting block 1173 and a second limiting block 1174. The first limiting block 1173 is arranged outside the filter cartridge 115, the second limiting block 1174 is arranged inside the filter cartridge 115, and the spring 1172 is arranged between the second limiting block 1174 and the inner wall of the filter cartridge 115.

With the first stop block 1173, the stop rod 1171 can be can well prevented from completely moving into the filter cartridge 115, and with the second stop block 1174, the stop rod 1171 can be well prevented from completely moving out of the filter cartridge 115.

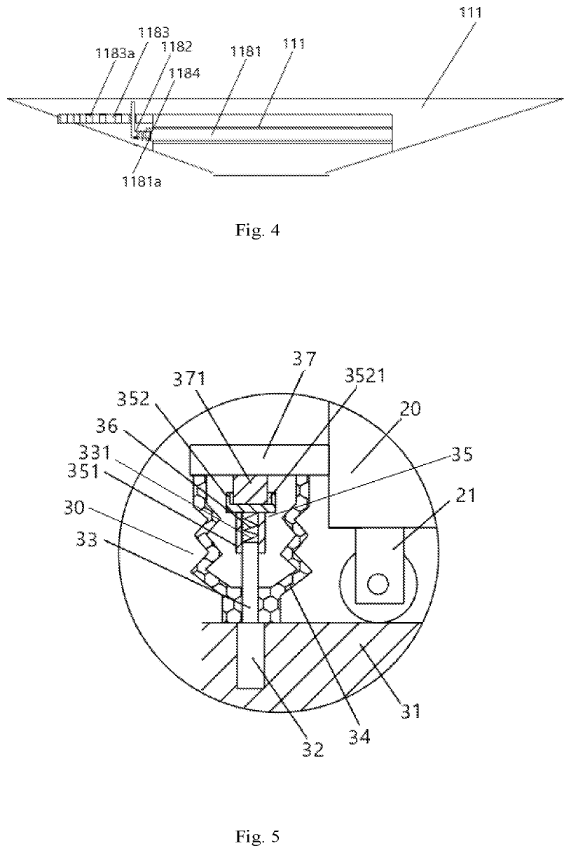

Further, Referring to FIG. 4, the grain color sorter 10 of this disclosure embodiment further includes an adjusting mechanism 118, which includes a movable plate 1181, a connecting member 1182 and a fixing rod 1183. An inner wall of the hopper 111 is symmetrically provided with sliding grooves 1111, the sliding grooves 1111 and the fixing rod 1183 are transversely arranged. The movable plate 1181 is movably connected with the sliding grooves 1111. The fixing rod 1183 is fixed to an outer wall of the hopper 111. The fixing rod 1183 is defined with a plurality of adjusting grooves 1183a along its length direction. The hopper 111 is defined with a third through hole 1156a. One end of the connecting member 1182 can penetrate through the third through hole 1156a to connect with the movable plate 1181, and the other end of the connecting member 1182 can be plugged into one of the adjusting grooves 1183a.

The movable plate 1181 is driven to move along one of the sliding grooves 1111 by moving of the connecting member 1182. Because the groove 1111 is transversely arranged, amount of grains entering the dropping cylinder from the hopper 111 can be adjusted during transverse movement of the movable plate 1181, and with the other end of the connecting member 1182 being inserted into different adjusting grooves 1183a, the movable plate 1181 can be fixed at different positions.

Illustratively, the connecting member 1182 is L-shaped, and the connecting member 1182 is movably connected with the movable plate 1181 through a bump 1184, and the movable plate 1181 is provided with a recess 1181a, the bump 1184 is connected with the connecting member 1182, the bump 1184 is arranged in the recess 1181a and can rotate relative to the recess 1181a, and a torsion spring is sleeved outside the connecting member 1182, one end of the torsion spring is connected with the bump 1184 and the other end of the torsion spring is connected with the connecting member 1182.

When an end of the connecting member 1182 needs to be inserted into the adjusting groove 1183a, the connecting member 1182 is rotated to make the bump 1184 rotate in the groove, and when the end of the connecting member 1182 is rotated into the adjusting groove 1183a, the movable plate 1181 can be fixed. A force of the torsion spring can make the connecting member 1182 be fixed in the adjusting groove 1183a well.

When a position of the movable plate 1181 needs to be adjusted, the connecting member 1182 of the adjusting groove 1183a is rotated to be separated from the adjusting groove 1183a, and then the connecting member 1182 is pulled to move, thereby driving the movable plate 1181 to move.

Further, Referring to FIGS. 1 and 5, the grain color sorter 10 further includes a grounding device 30, which includes a connecting rod 33, a grounding rod 32 embedded in the ground 31, an elastic member 36, an abutting member 35 and a supporting piece connected with the body 20 of the grain color sorter 10.

The abutting member 35 is slidably matched with the connecting rod 33 and can move along the axial direction of the connecting rod 33. One end of the connecting rod 33 is connected with the grounding rod 32, one end of the elastic member 36 acts on the connecting rod 33 and the other end of the elastic member 36 acts on the abutting member 35 to make the abutting member 35 abut against the supporting piece 37, the other end of the connecting rod 33 is defined with a limiting groove 331, the elastic member 36 is arranged in the limiting groove 331.Optionally, the elastic member 36 is a spring.

With the grounding device 30 of this embodiment, since the body 20 is connected with the supporting piece 37, the abutting member 35 abuts against the supporting piece 37 and slidably cooperates with the connecting rod 33, the connecting rod 33 is connected with the grounding rod 32, and the grounding rod 32 is embedded in the ground 31, a current can sequentially flow through the body 20, the supporting piece 37, the abutting member 35, the connecting rod 33 and the grounding rod 32 so as to be guided to the ground 31 when electric leakage occurs in the grain color sorter 10.The elastic member 36 is arranged in the limiting groove 331 of the connecting rod 33, so radial movement of the elastic member 36 is limited. Because the abutting member 35 abuts against the supporting piece 37 under the action of the elastic member 36, so that the abutting member 35 is stably connected with the supporting piece 37, and no open-circuit state occurs, thus presenting a good grounding protection function and improving safety of the grain color sorter 10.

Further, the abutting member includes a connecting bushing 351 and a clamping seat 352. The bushing 351 is sleeved on an outer wall of the connecting rod 33, the clamping seat 352 is arranged at the other end of the connecting rod 33, and the other end of the elastic member 36 acts on the clamping seat 352 and makes the clamping seat 352 abut against the supporting piece 37.

The elastic member 36 acts on the clamping seat 352, so that a connection between the clamping seat 352 and the supporting piece 37 is stable, and no open circuit state occurs. The sleeve 351 is sleeved on an outer wall of the connecting rod 33, so that an open circuit state doses not easily occur between the sleeve 351 and the connecting rod 33, which further improves the grounding protection and the safety of the grain color sorter 10.

Illustratively, the supporting piece 37 includes a bump 371, and the clamping seat 352 has a groove 3521 that can be matched with the bump 371, and the bump 371 is disposed in the groove 3521.

Through cooperation of the bump 371 and the groove 3521, the connection between the clamping seat 352 and the supporting plate 37 is more stable, which further reduces occurrence of an open-circuit state and further improves the grounding protection.

Further, in a possible implementation, the outer wall of the connecting rod 33 is provided with a corrugated pipe 34 one end of which is connected with the supporting piece 37 and the other end of which is used for connecting with the ground 31.

When the body 20 vibrates, the corrugated pipe 34 presents cushioning effect. Optionally, the corrugated pipe 34 is made of rubber.

A grain color sorter 10 is further provided in this embodiment, which includes a body 20 and the grounding device 30 described above, and the supporting piece 37 is connected with the body 20.

Optionally, a bottom of the body 20 is provided with wheels 21 for contacting with the ground 31.With the wheels 21 provided, it is more convenient for the grain color sorter 10 to move.

To sum up, in the grain color sorter 10 with the filter device 11 according to embodiments of this disclosure, Grains can fall into the drop tube 112 from the hopper 111, and then enters the body 101 for color sorting. When the grains are in the drop tube 112, because there is a fan 1141 in the ventilation duct 114, under an action of the fan 1141, the air and dust enter the sleeve 113 through the first through hole 1121 of the drop tube 112, then enter the ventilation duct 114 through the sleeve 113, and then enter the filter cartridge 115; after being filtered by the filter screen 1154, the dust is trapped, and the gas flows out from the opening 1152 of the filter cartridge 115. By disassembling the end cap 1151, the trapped dust can be removed from the filter cartridge 115.The grain color sorter 10 presents good dust removal effect, which can reduce dust content in the grains and improve processing quality of the grains.

In addition, since the body 20 is connected with the supporting piece 37, the abutting member 35 abuts against the supporting piece 37 and slidably cooperates with the connecting rod 33, the connecting rod 33 is connected with the grounding rod 32, and the grounding rod 32 is embedded in the ground 31, a current can sequentially flow through the body 20, the supporting piece 37, the abutting member 35, the connecting rod 33 and the grounding rod 32 so as to be guided to the ground 31 when electric leakage occurs in the grain color sorter 10.Because the abutting member 35 abuts against the supporting piece 37 under the action of the elastic member 36, so that the abutting member 35 is stably connected with the supporting piece 37, and no open-circuit state occurs, thus presenting a good grounding protection function and improving safety of the grain color sorter 10.

The above is only specific embodiments of this disclosure, and is not intended to limit this disclosure, and modifications and variations can be made in this disclosure for those skilled in the art. Any modification, equivalent substitution, improvement, etc. made within the spirit and principle of this disclosure shall be encompassed within the protection scope of this disclosure.

What is claimed is:

1. A grain color sorter with a filtering device, comprising a filtering device, the filtering device comprising a hopper, a drop tube, a sleeve, a ventilation duct and a filter cartridge; wherein the drop tube and the sleeve are both connected with a body of the grain color sorter, the body is provided with a feed inlet, the drop tube is communicated with the feed inlet, a wall of the drop tube is defined with a first through hole, the sleeve is sleeved on the drop tube and has a gap with the drop tube, and an inside of the drop tube is communicated with the sleeve through the first through hole; a feed outlet of the hopper is communicated with the drop tube;
the ventilation duct is communicated with inside of the sleeve, and a fan is installed in the ventilation duct; and
one end of the filter cartridge is detachably connected with an end cap, the other end of the filter cartridge is provided with an opening, a wall of the filter cartridge is defined with a second through hole, the filter cartridge is communicated with the ventilation duct through the second through hole, a filter screen is installed inside the filter cartridge, and the filter screen is installed at an end of the filter cartridge close to the opening.

2. The grain color sorter with the filtering device according to claim 1, further comprising a pull rod, a supporting piece and a limiting mechanism, wherein the supporting piece is installed in the filter cartridge and slidably connected with the inner wall of the filter cartridge; the filter screen is fixed to the supporting piece. The supporting piece is defined with a third through hole. The pull rod is connected with the supporting piece; and the limiting mechanism is used for fixing the supporting piece in the filter cartridge.

3. The grain color sorter with the filtering device according to claim 2, wherein an outer wall of the pull rod is provided with an annular groove which is circumferentially arranged along the pull rod, the limiting mechanism comprises a limiting rod; and an outer wall of the filter cartridge is defined with a guide hole and the limiting rod penetrates through the guide hole and abuts against the annular groove.

4. The grain color sorter with the filtering device according to claim 3, wherein the limiting rod is sleeved with a spring.

5. The grain color sorter with the filtering device according to claim 4, wherein the limiting rod is provided with a first limiting block and a second limiting block, the first limiting block being arranged outside the filter cartridge, the second limiting block being arranged inside the filter cartridge, and the spring being arranged between the second limiting block and the inner wall of the filter cartridge.

6. The grain color sorter with the filtering device according to claim 1, further comprising an adjusting mechanism, wherein the adjusting mechanism comprises a movable plate, a connecting member and a fixing rod, wherein an inner wall of the hopper is symmetrically provided with sliding grooves, the sliding grooves and the fixing rod are transversely arranged; the movable plate is movably connected with the sliding grooves, the fixing rod is fixed to an outer wall of the hopper; the fixing rod is defined with a plurality of adjusting grooves along its length direction; the hopper is defined with a third through hole, one end of the connecting member penetrates through the third through hole to connect with the movable plate, and the other end of the connecting member is plugged into one of the adjusting grooves.

7. The grain color sorter with the filtering device according to claim 6, wherein the connecting member is L-shaped, and the connecting member is movably connected with the movable plate through a bump, and the movable plate is provided with a recess, the bump is connected with the connecting member, the bump is arranged in the recess and rotates relative to the recess, and a torsion spring is sleeved outside the connecting member, one end of the torsion spring is connected with the bump and the other end of the torsion spring is connected with the connecting member.

8. The grain color sorter with the filtering device according to claim 1, further comprising a grounding device, wherein the grounding device comprises a connecting rod, a grounding rod embedded in the ground, an elastic member, an abutting member and a supporting piece connected with the body of the grain color sorter, the abutting member being slidably matched with the connecting rod and moving along an axial direction of the connecting rod;
one end of the connecting rod being connected with the grounding rod, the other end of the connecting rod being defined with a limiting groove, the elastic member being arranged in the limiting groove, one end of the elastic member acting on the connecting rod and the other end of the elastic member acting on the abutting member to make the abutting member abut against the supporting piece.

9. The grain color sorter with the filtering device according to claim 8, wherein the abutting member comprises a connecting bushing and a clamping seat, wherein the bushing is sleeved on an outer wall of the connecting rod, the clamping seat is arranged at the other end of the connecting rod, and the other end of the elastic member acts on the clamping seat and makes the clamping seat abut against the supporting piece.

10. The grain color sorter with the filtering device according to claim 8, wherein the outer wall of the connecting rod is provided with a corrugated pipe one end of which is connected with the supporting piece and the other end of which is used for connecting with the ground.
